(19) United States
(12) Patent Application Publication
(10) Pub. No.: US 2008/0061694 A1
(43) Pub. Date: Mar. 13, 2008

(54) PLASMA DISPLAY PANEL AND RELATED TECHNOLOGIES

(75) Inventor: Kyung Ku KIM, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/854,791

(22) Filed: Sep. 13, 2007

(30) Foreign Application Priority Data
Sep. 13, 2006 (KR) 10-2006-0088517

(51) Int. Cl. H01J 17/49; H01J 9/00

(52) U.S. Cl. 313/582; 445/24

(57) ABSTRACT

A method of manufacturing a plasma display panel includes bonding a transparent resin onto a substrate, injecting conductive paste to a mask having an engraved pattern, and transferring the injected conductive paste onto the transparent resin.

### CROSS-REFERENCE TO RELATED APPLICATION

This application claims the benefit of Korean Patent Application No. 10-2006-0088517, filed on Sep. 13, 2006, which is hereby incorporated by reference in its entirety as if fully set forth herein.

### BACKGROUND

1. Technical Field

This document relates to a plasma display panel and related technologies.

2. Description of the Related Art

A plasma display panel (hereinafter, referred to as “PDP”) is a light-emitting device which displays images using an electrical discharge phenomenon. Since it is unnecessary to mount an active device on each cell in the plasma display panel, a manufacturing process of the plasma display panel is simple. Further, since the plasma display panel facilitates scaling-up of a screen and has a high response speed, it is widely used as an image display device having a large screen.

An electromagnetic interference (EMI) shielding film may be disposed on the entire surface of an image display device to shield emission of electromagnetic waves from the device. The EMI shielding film has a specified conductive pattern to ensure visible ray transmissivity required in the display device while shielding electromagnetic wave.

Such an EMI shielding film may be adapted to a PDP, as an image display device. Methods for forming the EMI shielding film of the PDP include a photoetching method, an offset method and the like. The offset method, which is cost-effective, is performed as follows.

FIG. 1 schematically shows a general example of offset method. First, as shown in FIG. 1, paste 12 is coated on a master mold 10 with an engraved pattern 11 such that the paste 12 is injected into the engraved pattern 11. Then, the paste 12 patterned on the master mold 10 is transferred to a blanket 13. In this case, the blanket 13 includes a roller 15 made of metal and an outer cover 14 made of silicone. The blanket 13 is manufactured to have a circumference equal to the length of the master mold 10. Then, the paste 12 transferred to the blanket 13 is retransferred to a front substrate 16 of the PDP and sintered, thereby forming the EMI shielding film.

In the general offset method, a siloxane-based blanket material, which has a desired releasing property, is used to achieve desired offset characteristics in the paste.

### SUMMARY

In one general aspect, a method of manufacturing a plasma display panel includes bonding a transparent resin onto a substrate, injecting conductive paste to a mask having an engraved pattern, and transferring the injected conductive paste onto the transparent resin.

In another general aspect, a method of manufacturing a front filter includes injecting conductive paste to a mask having an engraved pattern, and transferring the injected conductive paste onto a transparent resin.

In yet another general aspect, a method of manufacturing a plasma display panel includes bonding a transparent resin onto a substrate, and forming a plurality of non-contiguous electromagnetic interference shielding regions on the transparent resin.

In yet another general aspect, a plasma display panel includes a first substrate, a second substrate and a front filter disposed on the first substrate. The first substrate includes at least one pair of sustain electrodes, a dielectric layer located on the sustain electrodes and a protective film located on the dielectric layer. The second substrate faces the first substrate and includes at least one address electrode, a dielectric layer located on the address electrode and a phosphor layer located on the dielectric layer. The front filter includes a transparent resin and a plurality of non-contiguous electromagnetic interference shielding regions located on the transparent resin.

Implementations may include one or more of the following features. For example, the mask may be a roll-type mask and transferring the injected conductive paste onto the transparent resin may include rolling the mask on the transparent resin. Also, injecting the conductive paste to the mask and rolling the mask on the transparent resin may temporally overlap. Alternatively, the mask may be a plate-type mask and transferring the injected conductive paste onto the transparent resin may include pressing the mask to the transparent resin.

Bonding the transparent resin on the substrate may include forming the transparent resin on a base film or a base glass and bonding the base film or a base glass on the substrate. The conductive paste may include a conductive material, a binder polymer and a solvent. Also, the conductive paste may further includes a black material. Excessive conductive paste protruding from the engraved pattern of the mask may be removed.

The transparent resin may be formed of one selected from a group consisting of polydimethylsiloxane (PDMS)-based resin, ethylene vinyl acetate (EVA)-based resin, acrylic resin, urethane acrylate-based resin, ethacrylate-based resin, vinyl-based resin, methacrylic resin, and resin having a reaction group such as an alkyl group, an unsaturated higher fatty acid group, a tetrahydrofurfuryl group and a benzyl ether group. The electromagnetic interference shielding regions may include a material selected from the group consisting of Ag, Cu, Zn, Ni, Cr, Fe, Al, Ti, Co and ITO. Also, the electromagnetic interference shielding regions may further include a black material.

The electromagnetic interference shielding regions may include a line having a width of 10˜30 μm. Additionally or alternatively, the electromagnetic interference shielding regions may include lines of a conductive material with a distance between the lines being 150˜500 μm. The transparent resin may have a thickness of 100˜900 μm. The transparent resin may include a color dye or a near infrared (NIR) dye. A base film or a base glass may be disposed between the transparent resin and the first substrate through.

It is to be understood that both the foregoing general description and the following detailed description are exemplary and explanatory and are intended simply to provide further explanation.

### BRIEF DESCRIPTION OF THE DRAWINGS

The accompanying drawings, which are included to enhance understanding of various concepts and which are incorporated in and constitute a part of this application, illustrate various implementations.

FIG. 1 schematically illustrates a general example of offset method;

FIGS. 2A to 2K illustrate an example method of manufacturing a plasma display panel;

FIGS. 3A and 3B schematically illustrate an example method of manufacturing a front filter of a plasma display panel;

FIG. 4 illustrates another example method of manufacturing a front filter of a plasma display panel; and

FIG. 5 illustrates an example structure of a plasma display panel.

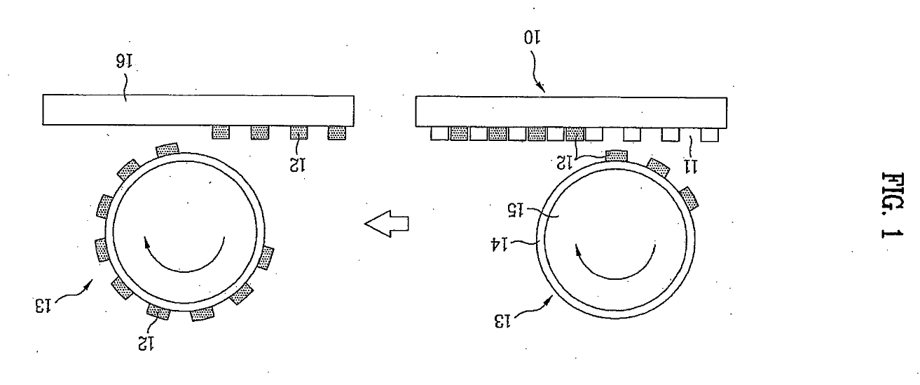

### DETAILED DESCRIPTION

Implementations are described with reference to the drawings. A dimension of a thickness is enlarged in the accompanying drawings to clearly represent several layers and regions. A thickness ratio of respective layers shown in the drawings is not equal to an actual thickness ratio. Meanwhile, when a portion such as a layer, a film, a region and a plate is shown or described as being formed or disposed “on” another portion, it should be understood that the disclosure contemplates forming the portion directly on the other portion through a direct contact, or indirectly through a further portion disposed therebetween.

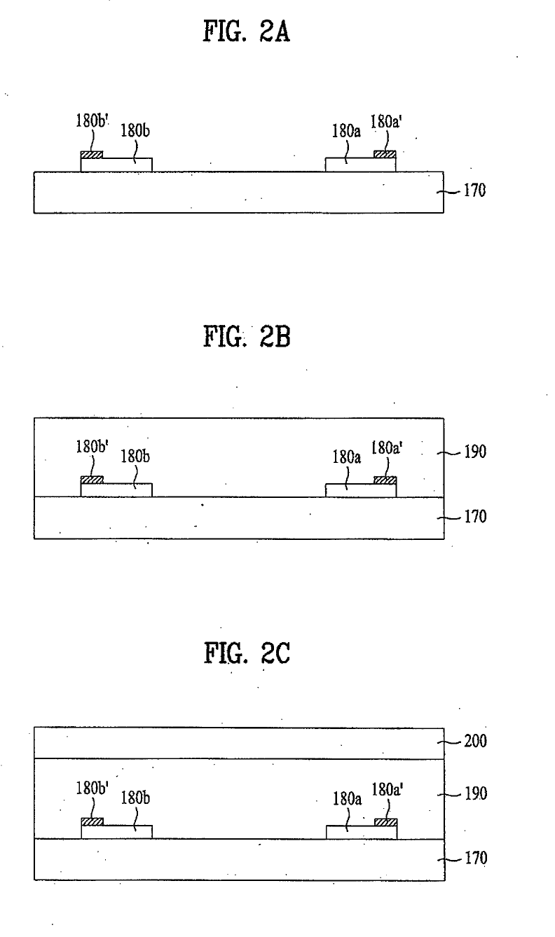

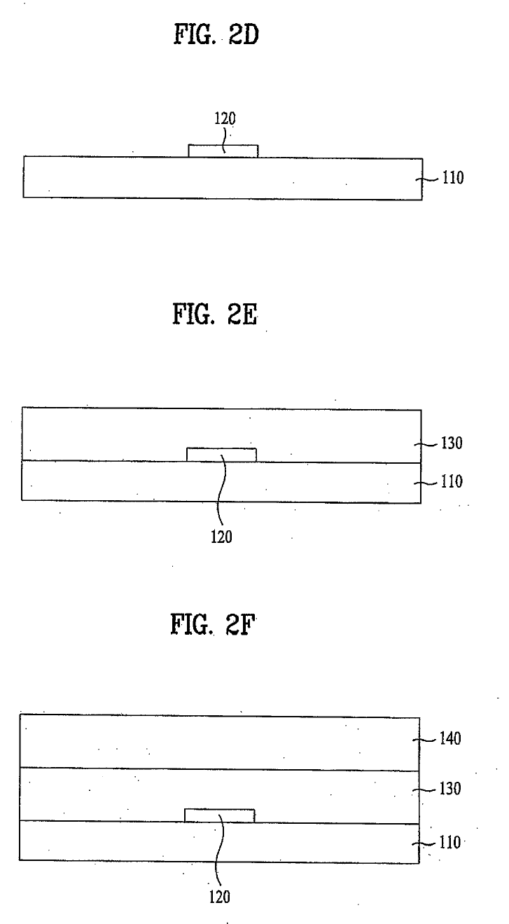

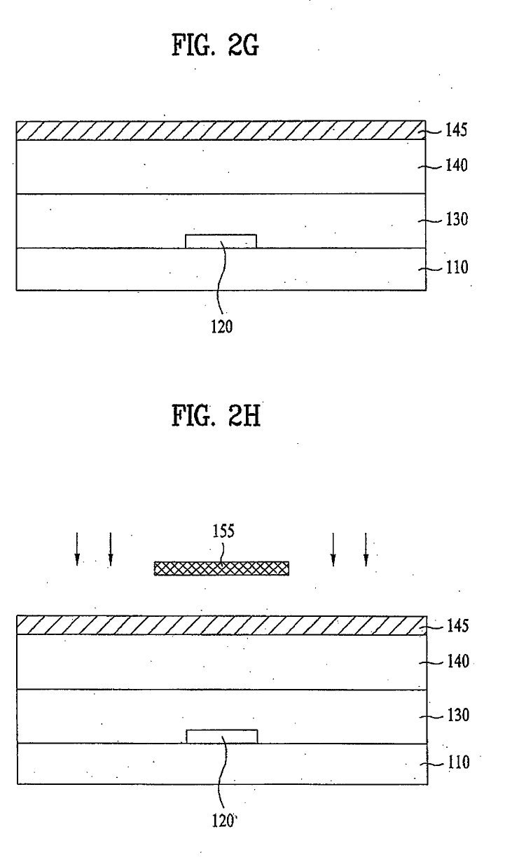

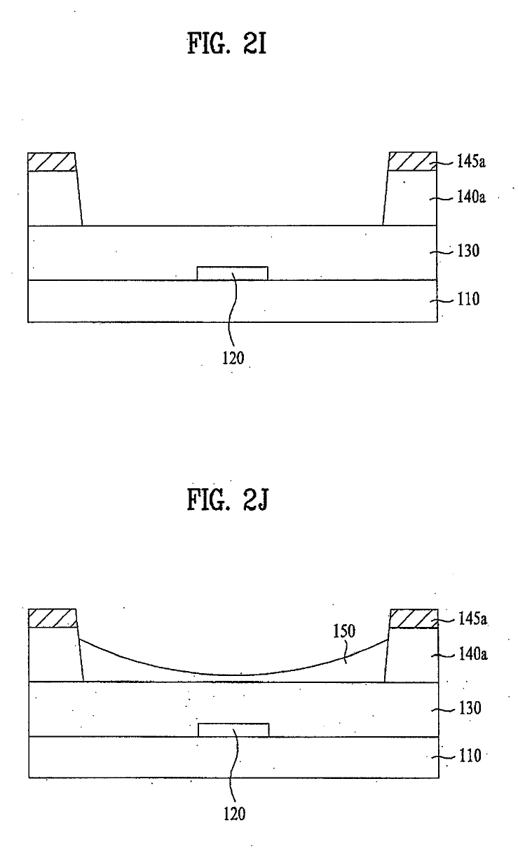

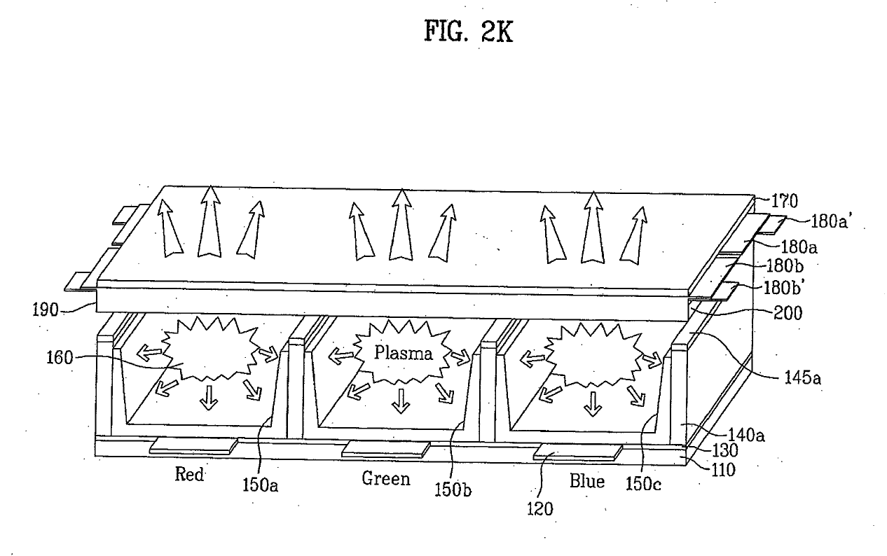

An examplary method of manufacturing a plasma display panel will be described referring to FIGS. 2A-2K.

First, as shown in FIG. 2A, transparent electrodes 180a and 180b and bus electrodes 180a′ and 180b′ are formed on a front substrate 170. The front substrate 170 is manufactured by milling and cleaning display substrate glass or soda-lime glass. The transparent electrode 180a is formed using indium tin oxide (ITO), SnO₂, or the like by performing a photoetching method employing sputtering or a lift-off method employing CVD. The bus electrode 180a′ is formed using Ag or the like by performing a screen printing method or a photosensitive paste method. Further, a black matrix may be formed on a pair of sustain electrodes by performing a screen printing method, a photosensitive paste method or the like using low melting point glass and black pigment.

Then, as shown in FIG. 2B, a dielectric layer 190 is formed on the front substrate 170 with the transparent electrodes 180a and 180b and bus electrodes 180a′ and 180b′ formed thereon. The dielectric layer 190 is formed by performing a screen printing method or a coating method using a material including low melting point glass or by laminating a green sheet.

Then, as shown in FIG. 2C, a protective film 200 is deposited on the dielectric layer 190. The protective film 200 may be formed using magnesium oxide or the like by performing an electron beam deposition, a sputtering method, an ion plating method or the like.

An upper panel of the plasma display panel is formed through the above process. Next, a process for manufacturing a lower panel is explained.

As shown in FIG. 2D, an address electrode 120 is formed on a rear substrate 110. The rear substrate 110 is formed by milling and cleaning display substrate glass or soda-lime glass. Then, the address electrode 120 is formed on the rear substrate 110. The address electrode 120 is formed using Ag or the like by performing a screen printing method, a photosensitive paste method, a photoetching method after sputtering or the like.

Then, as shown in FIG. 2E, a dielectric layer 130 is formed on the rear substrate 110 with the address electrode 120 formed thereon. The dielectric layer 130 is formed on the lower panel by performing a screen printing method using a material including low melting point glass and filler (e.g., TiO₂) or by laminating a green sheet. In this case, preferably, the dielectric layer 130 of the lower panel exhibits a white color to increase the brightness of the plasma display panel.

Then, as shown in FIG. 2F, a partition wall material 140 is coated to later form partition walls to separate respective discharge cells. The partition wall material 140 includes helmet-shaped glass and filler. The helmet-shaped glass may include PbO, SiO₂, B₂O₃ and Al₂O₃. The filler may include TiO₂ and Al₂O₃.

Further, as shown in FIG. 2G, a black top material 145 is coated on the partition wall material 140. The black top material 145 includes a solvent, inorganic powder, and an additive. Further, the inorganic powder includes glass frit and black pigment. Then, the partition wall structure with the black top are formed by patterning the partition wall material and the black top material, as described below.

A patterning process is described with reference to FIGS. 2H and 2I. The patterning process is performed through exposure and development after forming a mask 155. That is, after the mask 155 is positioned at a portion corresponding to the address electrode 120, exposure, developing and sintering processes are performed. Accordingly, only a portion on which light is illuminated remains, thereby forming a partition wall 140a and a black top 145a. When the black top material includes a photoresist material, patterning of the partition wall material and the black top material can be easily performed. Further, when both the black top material and the partition wall material are sintered, a bonding force between the helmet-shaped glass in the partition wall material and the inorganic powder in the black top material increases, thereby enhancing durability.

Then, as shown in FIG. 2J, a phosphor 150 is coated on the surface of the dielectric layer 130 and the side surface of the partition wall 140a that is to be exposed to the discharge space. Red, green and blue phosphors 150 are coated in order according to the respective discharge cells by performing a screen printing method, a photosensitive paste method or the like.

Then, as shown in FIG. 2K, after joining and sealing the upper panel and the lower panel with the partition wall disposed therebetween, impurities are exhausted therefrom and a discharge gas 160 is injected.

One illustrative process of forming a front filter on the front substrate will now be described. The front filter may be formed after assembling the upper panel and the lower panel. Alternatively, after the front filter is formed on the upper panel, the upper panel and the lower panel may be assembled.

First, a mask with an engraved pattern is prepared. The mask may be a roll type mask or a plate type mask. Then, conductive paste is injected into the mask with an engraved pattern. The conductive paste may include any one selected from the group consisting of Ag, Cu, Zn, Ni, Cr, Fe, Al, Ti, Co and ITO. For example, the conductive paste may be a metal material such as Ag, Cu, Zn, Ni, Cr, Fe, Al, Ti and Co, an oxide of the metal, or a conductive oxide such as ITO. Then, the conductive paste is transferred to transparent resin to form an electromagnetic interference (EMI) shielding film. The conductive paste further includes a binder polymer and a solvent in addition to the above-mentioned conductive material. The binder polymer and the solvent are removed through drying and sintering processes after transferring the conductive paste. The conductive paste may further include a black material. When the EMI shielding film including the black material is formed, reflectivity of the plasma display panel decreases, thereby improving contrast.

The transparent resin may be formed of one selected from the group consisting of polydimethylsiloxane (PDMS)-based resin, ethylene vinyl acetate (EVA)-based resin, acrylic resin, urethane acrylate-based resin, ethacrylate-based resin, vinyl-based resin, methacrylic resin, and resin having a reaction group such as an alkyl group, an unsaturated higher fatty acid group, a tetrahydrofurfuryl group and a benzyl ether group.

The transparent resin may have a thickness of 10 μm˜10 mm. For example, the transparent resin has a thickness of 100 μm˜900 μm. If the transparent resin has a thickness less than 100 μm, the conductive paste is not efficiently transferred due to a very small thickness even though transmissivity is high, whereas if the transparent resin has a thickness more than 900 μm, although the conductive paste is efficiently transferred, transparency decreases and transmissivity is reduced.

The transparent resin may further include a color dye or a near infrared (NIR) dye. That is, the transparent resin may be formed of a single layer with a color compensation film or a near infrared ray shielding film. The color compensation film includes a color dye for controlling a color to enhance color purity. The near infrared ray shielding film serves to prevent near infrared rays stronger than a reference value from being emitted to the outside by using the NIR dye, which prevents signals that are normally transmitted to the panel from a device such as a remote controller, which uses near infrared rays.

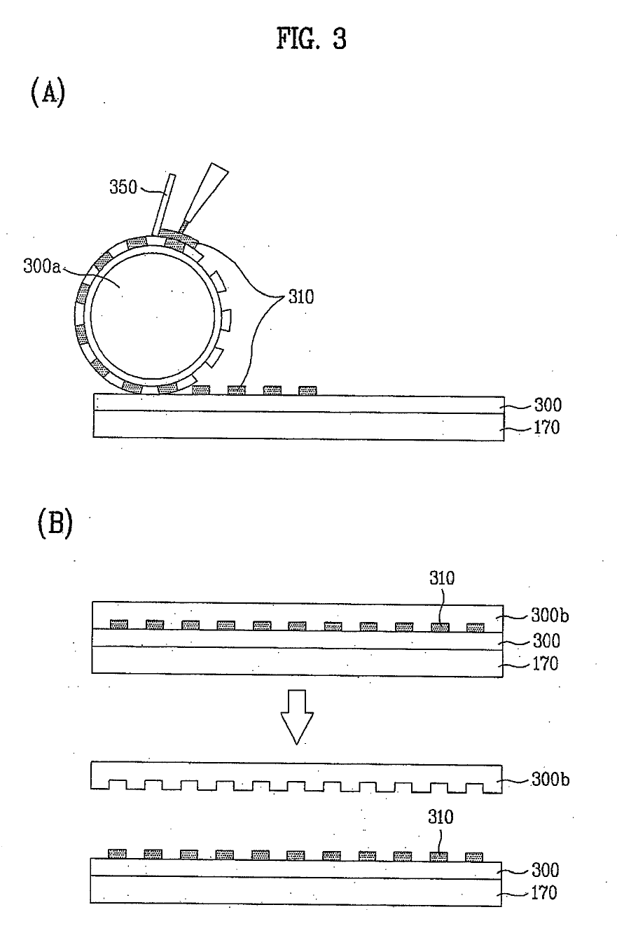

FIGS. 3A and 3B schematically show an example process for manufacturing a front filter of a plasma display panel. As shown in FIG. 3A, a transparent resin 300 is bonded onto the front substrate 170 of the plasma display panel. Conductive paste 310 is transferred onto the transparent resin 300 by rolling a roll-type mask 300a on the transparent resin 300. Further, a blade 350 is used to remove excessive amount of the conductive paste 310 injected into the mask 300a. That is, when the conductive paste 310 is injected into the mask 300a with an engraved pattern, the excessive amount of the conductive paste 310 after filling the mask 300a may be protruded from the mask 300a. In this case, the remainder of the conductive paste is removed using the blade 350, thereby forming an EMI shielding film with a low defect ratio.

FIG. 3B shows an example process for forming an EMI shielding film using a plate-type mask 300b. In this case, the conductive paste 310 is transferred onto the transparent resin 300 by pressing the mask 300b to the transparent resin 300.

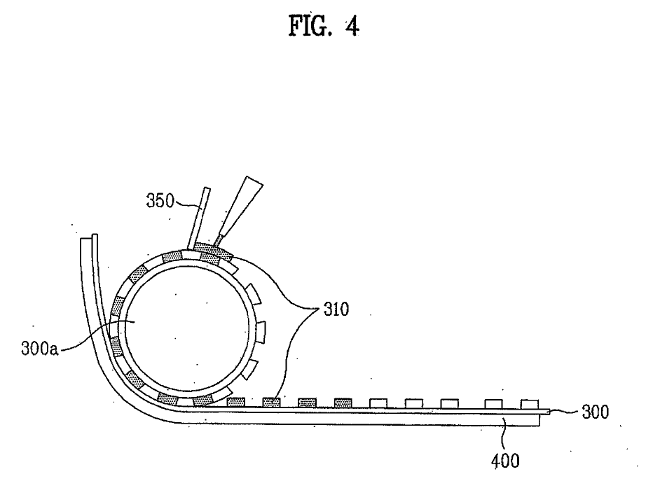

FIG. 4 illustrates another example method of manufacturing a front filter of a plasma display panel.

Although the roll-type mask 300a is shown in FIG. 4, a plate-type mask may be used alternatively. While the transparent resin is directly bonded onto the front substrate in the example shown in FIGS. 3A and 3B, a film-type or glass-type front filter is formed in the example shown in FIG. 4. The transparent resin 300 is formed on a base film 400 or glass. The conductive paste 310 is transferred onto the transparent resin 300. The detailed description thereof will follow below.

After the mask 300a with an engraved pattern is prepared, the conductive paste 310 is injected into the mask 300a. Then, the conductive paste 310 is transferred onto the transparent resin 300 disposed on the base film 400 of the front filter, thereby forming an EMI shielding film. The base film 400 may be formed of one selected from the group consisting of polyethylene terephthalate (PET), triacetyl cellulose (TAC), polymethyl methacrylate (PMMA) and polyamide (PA). Excessive amount of the conductive paste protruding from the engraved pattern may be removed using the blade 350.

As described above, in the example method of manufacturing a plasma display panel, the EMI shielding film is formed while the paste is directly injected and transferred without using a general offset method. Accordingly, the printing process can be expedited. Also, in the general offset method of using a siloxane-based blanket material, the siloxane-based blanket tends to be swollen by a solvent of ink and the blanket may lose initial offset characteristics due to a change in surface characteristics. Accordingly, a refrying process is needed in order to reuse the blanket, which is not cost-effective.

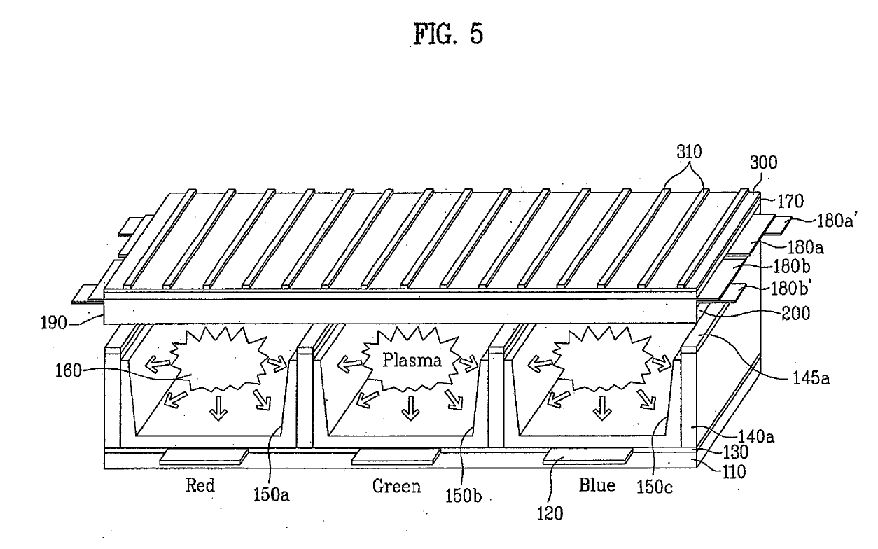

Hereinafter, an example structure of a plasma display panel will be described with reference to FIG. 5. The plasma display panel is formed using the above-described manufacturing method.

In the plasma display panel, a pair of sustain electrodes is formed on a front substrate 170 in one direction, wherein the sustain electrodes include a pair of transparent electrodes 180a and 180b generally formed of indium tin oxide (ITO) and bus electrodes 180a′ and 180b′ generally formed of a metal material. Then, a dielectric layer 190 and a protective film 200 are sequentially formed on the entire surface of the front substrate 170 to cover the pair of sustain electrodes.

The front substrate 170 is formed by milling and cleaning display substrate glass. The transparent electrodes 180a and 180b are formed using indium tin oxide (ITO), SnO₂, or the like by performing a photoetching method employing sputtering or a lift-off method employing CVD. Further, the bus electrodes 180a′ and 180b′ are formed to include Ag or the like. Further, a black matrix may be formed on the electrodes 180a and 180b to include low melting point glass, black pigment and the like.

As such, an upper dielectric layer 190 is formed on the front substrate 170 with the transparent electrodes and bus electrodes formed thereon. The upper dielectric layer 190 includes transparent low melting point glass. Further, a protective film 200 made of magnesium oxide or the like is formed on the upper dielectric layer 190, thereby protecting the upper dielectric layer 190 from positive ion impact during a discharge or increasing secondary electron emission.

Address electrodes 120 are formed on the surface of a rear substrate 110 in a direction crossing the direction of the sustain electrodes. A white dielectric layer 130 is formed on the entire surface of the rear substrate 110 to cover the address electrodes 120. The white dielectric layer 130 formed on the entire surface of the rear substrate 110 includes low melting point glass and filler (e.g., TiO₂). The white dielectric layer 130 is formed by laminating and sintering using a film laminating method or a screen printing method.

Partition walls 140a are formed on the white dielectric layer 130 to be arranged between the respective address electrodes 120. The partition walls 140a may have a stripe-type structure, a well-type structure, or a delta-type structure. Red (R), green (G) and blue (B) phosphor layers 150a, 150b and 150c are formed between the respective partition walls 140a. Discharge cells are respectively formed at portions where the address electrodes 120 disposed on the rear substrate 110 and the sustain electrodes disposed on the front substrate 170 cross each other.

An address discharge is performed by applying an address voltage between the address electrodes 120 and one of the sustain electrodes. Accordingly, a wall voltage is formed at a cell in which a discharge is generated. A sustain voltage is applied between the pair of sustain electrodes to generate a sustain discharge at the cell in which a wall voltage is formed. Vacuum ultraviolet rays generated by the sustain discharge cause the corresponding phosphor to be excited and to emit light. Accordingly, visible rays are emitted through the transparent front substrate 170, thereby forming a screen of the plasma display panel.

A transparent resin 300 is formed on the front substrate 170. The transparent resin 300 may be directly formed on the front substrate 170 or formed on a glass or a film which is placed on the front substrate 170. The transparent resin 300 may be formed of one selected from the group consisting of polydimethylsiloxane (PDMS)-based resin, ethylene vinyl acetate (EVA)-based resin, acrylic resin, urethane acrylate-based resin, ethacrylate-based resin, vinyl-based resin, methacrylic resin, and resin having a reaction group such as an alkyl group, an unsaturated higher fatty acid group, a tetrahydrofurfuryl group and a benzyl ether group. Further, the transparent resin may have a thickness of 10 μm˜10 mm. For example, the transparent resin may have a thickness of 100 μm˜900 μm. Further, the transparent resin may include a color dye or a near infrared (NIR) dye.

Further, an EMI shielding film 310 is patterned on the transparent resin 300. The EMI shielding film 310 may be formed in a stripe-type or mesh-type pattern. Ag, Cu, Zn, Ni, Cr, Fe, Al, Ti, Co, ITO and the like may be used for a conductive material of the EMI shielding film 300. Further, when a black material is added to the conductive material, it is possible to improve contrast as described above.

The conductive material may have a line width of 10˜30 μm. If the line width of the conductive material is larger than 30 μm, light emitted from the phosphor may be blocked. Further, if the line width of the conductive material is smaller than 10 μm, the EMI shielding effect may be insufficient. The respective lines are spaced from each other at a distance of 150˜500 μm. For example, the respective lines are spaced from each other at a distance of 300 μm. The reason for limiting the distance of the respective lines is the same as the reason for limiting the line width of the respective lines.

Other implementations are within the scope of the following claims.

What is claimed is:

1. A method of manufacturing a plasma display panel comprising:
bonding a transparent resin onto a substrate;
injecting conductive paste to a mask having an engraved pattern; and
transferring the injected conductive paste onto the transparent resin.

2. The method according to claim 1, wherein the mask is a roll-type mask and transferring the injected conductive paste onto the transparent resin includes rolling the mask on the transparent resin.

3. The method according to claim 2, wherein injecting the conductive paste to the mask and rolling the mask on the transparent resin temporally overlap.

4. The method according to claim 1, wherein the mask is a plate-type mask and transferring the injected conductive paste onto the transparent resin includes pressing the mask to the transparent resin.

5. The method according to claim 1, wherein bonding the transparent resin on the substrate includes forming the transparent resin on a base film or a base glass and bonding the base film or a base glass on the substrate.

6. The method according to claim 1, wherein the conductive paste includes a conductive material, a binder polymer and a solvent.

7. The method according to claim 6, wherein the conductive paste further includes a black material.

8. The method according to claim 1, further comprising removing excessive conductive paste protruding from the engraved pattern of the mask.

9. A plasma display panel comprising:
a first substrate including at least one pair of sustain electrodes, a dielectric layer located on the sustain electrodes and a protective film located on the dielectric layer;
a second substrate facing the first substrate and including at least one address electrode, a dielectric layer located on the address electrode and a phosphor layer located on the dielectric layer; and
a front filter disposed on the first substrate, the front filter including a transparent resin and a plurality of non-contiguous electromagnetic interference shielding regions located on the transparent resin.

10. The plasma display panel according to claim 9, wherein the transparent resin is formed of one selected from a group consisting of polydimethylsiloxane (PDMS)-based resin, ethylene vinyl acetate (EVA)-based resin, acrylic resin, urethane acrylate-based resin, ethacrylate-based resin, vinyl-based resin, methacrylic resin, and resin having a reaction group such as an alkyl group, an unsaturated higher fatty acid group, a tetrahydrofurfuryl group and a benzyl ether group.

11. The plasma display panel according to claim 9, wherein the electromagnetic interference shielding regions include a material selected from the group consisting of Ag, Cu, Zn, Ni, Cr, Fe, Al, Ti, Co and ITO.

12. The plasma display panel according to claim 11, wherein the electromagnetic interference shielding regions further include a black material.

13. The plasma display panel according to claim 9, wherein the electromagnetic interference shielding regions include a line having a width of 10˜30 μm.

14. The plasma display panel according to claim 9, wherein the electromagnetic interference shielding regions include lines of a conductive material with a distance between the lines being 150˜500 μm.

15. The plasma display panel according to claim 9, wherein the transparent resin has a thickness of 100˜900 μm.

16. The plasma display panel according to claim 9, wherein the transparent resin includes a color dye or a near infrared (NIR) dye.

17. The plasma display panel according to claim 9, wherein a base film or a base glass is disposed between the transparent resin and the first substrate through.

18. A method of manufacturing a front filter comprising:
injecting conductive paste to a mask having an engraved pattern; and
transferring the injected conductive paste onto a transparent resin.

19. The method according to claim 18, wherein the mask is a roll-type mask and transferring the conductive paste onto the transparent resin includes rolling the mask on the transparent resin.

20. The method according to claim 19, wherein injecting the conductive paste to the mask and rolling the mask on the transparent resin temporally overlap.

21. The method according to claim 18, wherein the mask is a plate-type mask and transferring the conductive paste onto the transparent resin includes pressing the mask to the transparent resin.

22. The method according to claim 18, wherein the conductive paste includes a conductive material, a binder polymer and a solvent.

23. The method according to claim 22, wherein the conductive paste further includes a black material.

24. The method according to claim 18, further comprising removing excessive conductive paste protruding from the engrave pattern of the mask.

25. A method of manufacturing a plasma display panel comprising:
bonding a transparent resin onto a substrate; and
forming a plurality of non-contiguous electromagnetic interference shielding regions on the transparent resin.
